(19) United States
(12) Patent Application Publication
(10) Pub. No.: US 2016/0294087 A1
(43) Pub. Date: Oct. 6, 2016

(54) ELECTRICAL CONNECTOR ADAPTER

(71) Applicant: HEWLETT PACKARD ENTERPRISE DEVELOPMENT LP, Houston, TX (US)

(72) Inventors: John Norton, Houston, TX (US); Joseph R. Allen, Tomball, TX (US)

(21) Appl. No.: 15/035,862

(22) PCT Filed: Nov. 26, 2013
(86) PCT No.: PCT/US13/72014

§ 371 Date: May 11, 2016

(51) Int. Cl. H01R 12/70; H01R 12/72

(52) U.S. Cl. CPC H01R 12/7082; H01R 12/721; H01R 12/7005

(57) ABSTRACT

Adapter with a housing body defining a chamber portion with first and second opposite side, electrical contacts arranged in a non-staggered pattern in a row across the first side of interior of chamber portion to make a non-hot-plug electrical connection with an electronic circuit board when the circuit board is inserted within interior of the chamber portion. The housing body defines an extension portion with a first side and a second opposite side. The electrical contacts arranged in a staggered pattern in a row across the first side of an exterior of the extension portion to make a hot-plug electrical connection with an external electrical connector. The electrical contacts provide continuous conductive paths between the chamber portion and the extension portion before the extension portion makes contact with the external connector. The electrical contacts have a higher insertion cycle characteristic than the electrical contact pads.

### BACKGROUND

Electrical connectors may include electrical contacts to establish electrical connections between electronic components such as electronic circuit boards and the like.

### BRIEF DESCRIPTION OF THE DRAWINGS

Certain examples are described in the following detailed description and in reference to the drawings, in which:

FIG. 1 shows a perspective view of an electrical connector adapter that is part of an electrical connector adapter assembly according to an example of the techniques of the present application.

FIG. 2A shows a perspective detailed top view of the electrical connector adapter of FIG. 1 according to an example of the techniques of the present application.

FIG. 2B shows a detailed top plan view of the electrical connector adapter of FIG. 2A according to an example of the techniques of the present application.

FIG. 2C shows a detailed cross section view of the electrical connector adapter of FIG. 2A taken across lines 2A-2A according to an example of the techniques of the present application.

FIG. 3A shows a perspective top view of electrical connector adapter of FIG. 1 as an initial step in the process of being assembled as part of a connector adapter assembly according to an example of the techniques of the present application.

FIG. 3B shows a detailed top plan view of electrical connector adapter of FIG. 3A in an initial step in the process of being assembled as part of a connector adapter assembly according to an example of the techniques of the present application.

FIG. 3C shows a detailed top plan view of electrical connector adapter of FIG. 3B in a further step in the process of being assembled as part of a connector adapter assembly according to an example of the techniques of the present application.

FIG. 3D shows a detailed top plan view of electrical connector adapter of FIG. 3C as a subsequent step in the process of being assembled as part of a connector adapter assembly according to an example of the techniques of the present application.

FIG. 4 shows a perspective view of another example of an electrical connector adapter that is part of an electrical connector adapter assembly according to the techniques of the present application.

### DETAILED DESCRIPTION OF SPECIFIC EXAMPLES

Electrical connectors may include electrical contacts to establish electrical connections between electronic components such as electronic circuit boards and the like. The electronic circuit boards may include Printed Circuit Boards (PCBs) with electronic components such as memory and processor electronic devices electrically connected to each other to provide computing or other data processing functionality. The PCBs may have electrical connectors such as card edge connectors with electrical contact pads that may allow the PCBs to be releasably coupled to external electrical connectors of separate electronic devices such as a computer devices configured as servers as part of computer or storage networks, for example. In this manner, the data processing functionality of the electronic circuit board may be coupled to the external computer devices to augment the functionality of the computer devices.

For example, the electronic circuit boards may include memory devices and when connected to a computer device may provide additional memory storage for use by the computer device. The computer devices or other systems may have electrical connectors configured to be hot-plug compatible. Hot-plug compatible may be defined as the capability of adding components to systems that may expand or increase system functionality without significant interruption to the operation of the system. However, some electronic circuit boards may have electrical connectors that are not hot-plug compatible. There may be a need for techniques to allow electronic circuit boards with electrical connectors that are not hot-plug compatible to be able to connect to systems with hot-plug compatible external connector configurations or other standard connector configuration layouts.

In one example of the present application, techniques are disclosed that may allow electronic circuit boards with electrical connectors that are not hot-plug compatible to be coupled to systems with hot-plug compatible electrical connectors or other standard connectors. In one example, disclosed is an electrical connector adapter with one end that receives or accepts a circuit board with a non-hot-plug compatible electrical connector layout or pattern and an opposite end that converts the pattern to a hot-plug compatible electrical connector layout or pattern. In this manner, a non-hot-plug compatible electronic circuit board may be coupled to a system with hot-plug compatible electrical connectors.

In one example of the present application, disclosed is an electrical connector adapter having a housing body that defines a chamber portion with a first and a second opposite side. The adapter includes electrical contacts proximate the chamber portion and arranged in a non-staggered pattern in a row across a first side of an interior of the chamber portion. This non-staggered pattern may allow a non-hot-plug electrical connection to be made with a electronic circuit board when the electronic circuit board is inserted within the interior of the chamber portion.

The housing body defines an extension portion with a first side and a second opposite side. The electrical contacts are arranged in a staggered pattern in a row across the first side of an exterior of the extension portion to make a hot-plug electrical connection with an external electrical connector. The electrical contacts comprise a single piece electrically conductive member with a resilient portion proximate the chamber portion that provides a continuous conductive path between the chamber portion and the extension portion before the extension portion is to make contact with the external connector. In this manner, an electronic circuit board with a non-hot-plug compatible connector may be coupled to a system with hot-plug compatible electrical connector or other standard configuration. Furthermore, in this manner, the adapter provides continuous conductive paths before making contact with the external connector which may reduce the need to have electronic switching circuitry as part of the adapter. Furthermore, these techniques may thereby help reduce the cost of the adapter and help increase the reliability of the adapter. The electrical contacts may be configured to have a higher insertion cycle characteristic than the electrical contact pads. In this manner, the adapter may be able to accept an electronic circuit board having relatively low insertion cycle characteristics and convert it to higher insertion cycle characteristics which may thereby increase the useful life of the electronic circuit board.

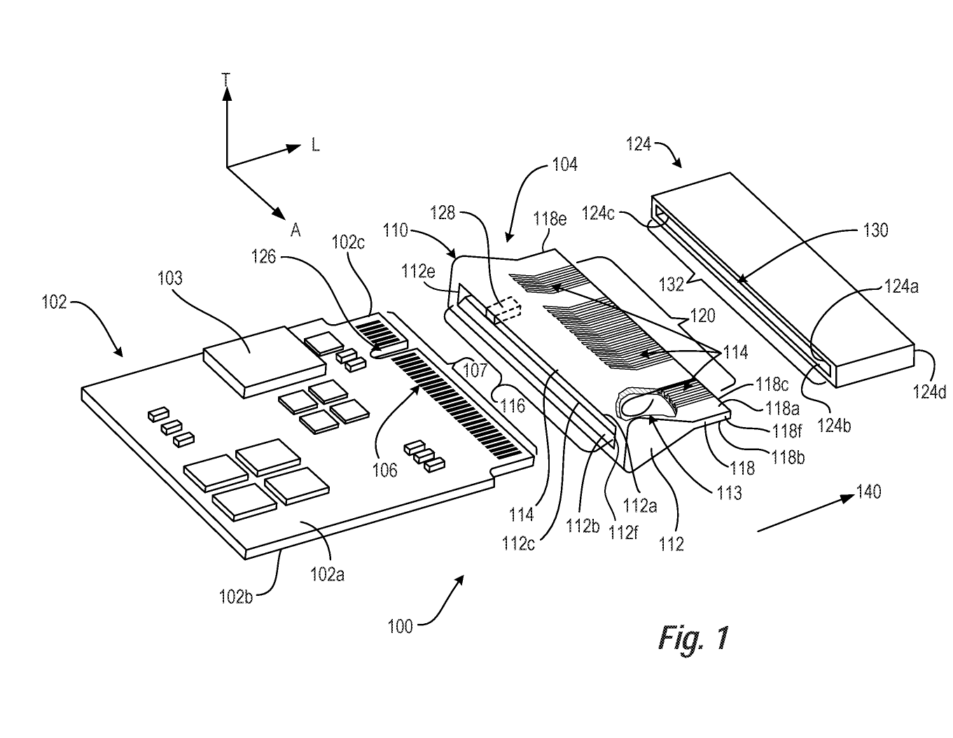

FIG. 1 shows a perspective view of an example electrical connector adapter that is part of an electrical connector adapter assembly 100 according to an example of the techniques of the present application.

The electronic circuit board 102 is capable of being assembled with an electrical connector adapter 104 to form assembly 100.

For illustrative purposes, assembly 100 is shown in a particular orientation where longitudinal direction L and lateral direction A extend horizontally, and transverse direction T extends vertically. However, it should be understood that these directions may change depending, for example, on the orientation of the assembly. The terms “longitudinal”, “lateral” and “transverse” are used to describe the perpendicular directional components of various components. The longitudinally forward direction L, which may be also represented by arrow 140 may also be referred to an insertion direction, as electronic circuit board 102 is mounted or engaged to electrical connector adapter 104 along a longitudinally forward insertion direction 140, and may be further mated to external electrical connector 124 along the longitudinally forward direction 140.

The electronic circuit board 102 includes a first side 102a and a second opposite side 102b. The electronic circuit board 102 includes electrical contact pads 106 disposed on first side 102a of the electronic circuit board. The contact pads 106 are arranged in a non-staggered pattern 107 in a row across first side 102a proximate card edge portion 102c of electronic circuit board 102. The electronic circuit board 102 may include electronic components 103 such as memory and computer devices interconnected for data processing purposes and the like. The electrical contact pads 106 may provide electrical conductive paths between the electronic components disposed on electronic circuit board 102 and external systems provided through electrical connector adaptor 104 of assembly 100. In one example, card edge portion 102c may be a card edge connector formed on a portion of electronic circuit board 102 that may include traces leading to the edge of the board that may be intended to be inserted or engaged into adapter 104 or other matching socket.

The electronic circuit board 102 may comprise any substrate material such as a PCB and the like for supporting electronic components. In one example, electronic circuit board 102 may be a PCB to provide electrical and mechanical support for electrical connection of electronic components using conductive pads, traces, tracks, pads and other features etched from copper sheets laminated onto a non-conductive substrate. In some examples, electronic circuit board 102 may be formed as a PCB single sided (one copper layer), double sided (two copper layers) or multi-layer. The electronic circuit board 102 may have conductors formed as different layers that are connected with plated-through holes referred to as vias. The electronic circuit board 102 may include passive components such as capacitors, resistors, inductors as well as active devices such as memory or processor devices formed or fabricated on the substrate. The electrical conductive pads 106 may be formed of any electrical conductive material such as copper and the like. It should be understood that electronic circuit board 102 shown in FIG. 1 is for illustrative purposes and that other examples may be applicable to be employed with the techniques of the present application. For example, electronic pads 106 may be disposed or formed on first side 102a, second side 102b or a combination thereof.

The electrical connector adapter 104 includes a housing body 110 that defines a chamber portion 112 and an extension portion 118.

The chamber portion 112 includes a first side 112a and an opposed second side 112b spaced from the first side 112a along a transverse direction T that extends substantially perpendicular with respect to the lateral direction A, and a third side 112e and an opposed fourth side 112f spaced from the third side 112e along a lateral direction A. The chamber portion 112 includes electrical contacts 114 arranged in a non-staggered pattern 116 in a row across first side 112a of an interior 112c of the chamber portion. In one example, non-staggered pattern 116 includes contacts with substantially the same length or single stage pattern along the longitudinal direction L to make electrical connection with complementary contacts at substantially the same time. This non-staggered pattern 116 allows adapter 104 to make a non-hot-plug electrical connection with complementary non-staggered contact pads 106 of first side 102a of electronic circuit board 102 when the electronic circuit board is inserted and securely mounted within interior 112c of chamber portion 112. The electrical connection establishes electrical communication or electrical conductive paths with and between electronic circuit board 102 and adapter 104 when contact pads 106 engage or make physical secure mechanical and electrical contact with electrical contacts of the adapter 104.

The extension portion 118 includes a first side 118a and an opposed second side 118b spaced from the first side 118a along a transverse direction T that extends substantially perpendicular with respect to the lateral direction A, and third side 118e and an opposed fourth side 118f spaced from the third side 118e along a lateral direction A. The extension portion 118 includes the electrical contacts 114 arranged in a staggered pattern 120 in a row across first side 118a of a connection edge 118c of the extension portion. In one example, staggered pattern 120 includes contacts with different lengths or multiple stage pattern along the longitudinal direction L to make electrical connection with complementary contacts at different times when engaged with external connector 124. This staggered pattern 120 allows adapter 104 to make a hot-plug electrical connection with an external electrical connector 124 having electrical contacts 130 arranged in a complementary staggered pattern 132 to that of pattern 120. In another example, electrical contacts 130 may be arranged in a complementary non-staggered pattern 132 to that of pattern 120. The electrical connection establishes electrical communication or electrical conductive paths with and between adapter 104 and external electrical connector 124 when electrical contacts 114 of the adapter 104 engage or make physical secure mechanical and electrical contact with electrical contacts 130 of the connector 124.

The chamber portion 112 is shown as configured to releasably secure electronic circuit board 102 within interior portion 112c of the chamber portion. In one example, the dimensions of the opening of interior portion 112c of chamber portion 112 are substantially complementary to the dimensions of the card edge portion 102c of electronic circuit board 102 so to provide a snug fit when card edge portion 102c is inserted into the interior portion 112c of the chamber portion. It should be understood that other securing mechanisms to physically releasably secure or engage may be used such as latching arms or other mechanical latching mechanisms and the like.

In a similar manner, extension portion 118 is shown as configured to releasably secure to interior portion 124c of external electrical connector 124. In one example, the dimensions of opening of interior portion 124c of connector 124 are substantially complementary to the dimensions of the connection edge 118c of extension portion 118 so to provide a snug fit when connection edge 118c is inserted into interior portion 124c of external electrical connector 124. It should be understood that other securing mechanisms to physically secure or engage may be used such as latching arms or other as mechanical latching mechanisms and the like.

The electrical contacts 114 of electrical connector adapter 104 may be configured to have a higher insertion cycle or characteristics than electrical contact pads 106 of electronic circuit board 102. The insertion cycle factor may be defined as a number of times or cycles that electrical contacts may be inserted and reinserted into complementary electrical connectors and still provide reliable mechanical operation. For example, contact pads 106 of printed circuit board 102 may have an insertion cycle of 50 meaning the contact pads may provide reliable operations for about 50 cycles of being inserted and reinserted into an electrical connector. On the other hand, electrical contacts 114 of adapter 104 may have an insertion cycle of 1000 meaning the electrical contacts 114 may provide reliable operations for about 1000 cycles of being inserted and reinserted into an electrical connector. In this manner, adapter 104 may be able to convert or provide an electronic circuit board having relatively low insertion cycle characteristics to higher insertion cycle characteristics which may thereby increase the useful life of the electronic circuit board.

In one example, the structure of contacts 106 of electronic circuit board 102 may be formed as relatively thin gold plated copper pads disposed proximate card edge 102c of electronic circuit board. Such a structure may typically have low insertion cycle characteristics compared to those of adapter 104. On the other hand, contacts 114 of adapter 104 may be formed of relatively thicker gold plated copper contacts pads compared to contacts pads of electronic circuit board. Such electrical contacts 114 of adapter 104 may help provide a more reliable or robust insertion and reinsertion operations and increase the life of electronic circuit board.

In one example, interior 112c of chamber portion 112 is shown to include a key portion 128 to mate or engage with a corresponding key portion 126 on electronic circuit board 102. The key mechanism may help ensure that electronic circuit board 102 is inserted or secured to the chamber portion in only one manner to prevent damage to the components. In one example, key portion 128 includes a ridge proximate one side of the chamber portion and key portion 126 includes a complementary slot proximate the same side of electronic circuit board 102 such that the ridge is configured to mate with the slot in only one manner. In this manner, if a user flips electronic circuit board 102 to the other side as shown and then attempts to insert the board into the adapter, the location of slot of the electronic circuit board would be on the opposite side of the location of the ridge and therefore the key mechanism would prevent the electronic circuit board from being inserted improperly in this configuration. It should be understood that the key mechanism shown in FIG. 1 is for illustrative purposes and that other key mechanisms may be used to implement the techniques of the present application.

The housing body 110 may be formed of any non-conductive or dielectric maternal such as plastic and the like. The housing body 110 may be formed or molded as a single housing member or formed from a plurality of housing members attached together using adhesive techniques such as glue and the like. It should be understood that adapter 104 shown in FIG. 1 is for illustrative purposes and other examples may be applicable to be used with the techniques of the present application. For example, electrical contacts 114 may be disposed or formed on first side 112a, second side 112b or a combination thereof. In a similar manner, electrical contacts 114 may be disposed or formed on first side 118a, second side 118b or a combination thereof. The electrical connector adapter 104 may include any electro-mechanical functionality for joining electrical circuits at an interface using a mechanical assembly.

The external electrical connector 124 is shown as having a generally rectangular shape along lateral direction A and longitudinal direction L. The connector 124 is shown having an interior portion 124c with interior dimensions substantially complementary to the dimensions of the connection edge 118c of extension portion 118 so to provide a snug fit when connection edge 118c is inserted into interior portion 124c of the external electrical connector 124. The external electrical connector 124 has an opposite side 124d to interior portion 124c which is configured to attach to an external electronic circuit board (not shown) such as a backplane, motherboard or the like. The contacts 130 of connector 124 may make electrical conductive paths with circuits or components connected to the external circuit board. In one example, external connector 124 may be disposed on a user accessible front portion of a computer such as a server computer to allow a user to insert adapter assembly comprising adapter 104 mated with electronic circuit board 102. In this manner, adapter 104 may allow a user to easily insert as well as remove a non-hot-plug electronic circuit board to computer system.

In one example, electronic circuit board 102 may be configured to conform to the Next Generation Form Factor (NGFF) which may also be referred to as the M.2 standard. The NGFF standard may include technology such as solid-state storage applications and the like. The electronic circuit board 102 may conform to the NGFF standard by having a card edge connector that is non-hot-plug compatible. In one example, external electrical connector 124 may have either a non-hot-plug or hot-plug compatible interface to be attached to a user accessible opening of a computer system such as a server as part of a data center or enterprise environment. In this case, using electrical connector adapter 104 in accordance with the techniques of the present application may allow such electronic circuit boards with non-hot-plug compatible connectors to be connected to computer systems having hot-plug compatible connectors.

It should be understood that adapter 104 in FIG. 1 is for illustrative purposes and that the adapter may be configured in a different manner to implement the techniques of the present application.

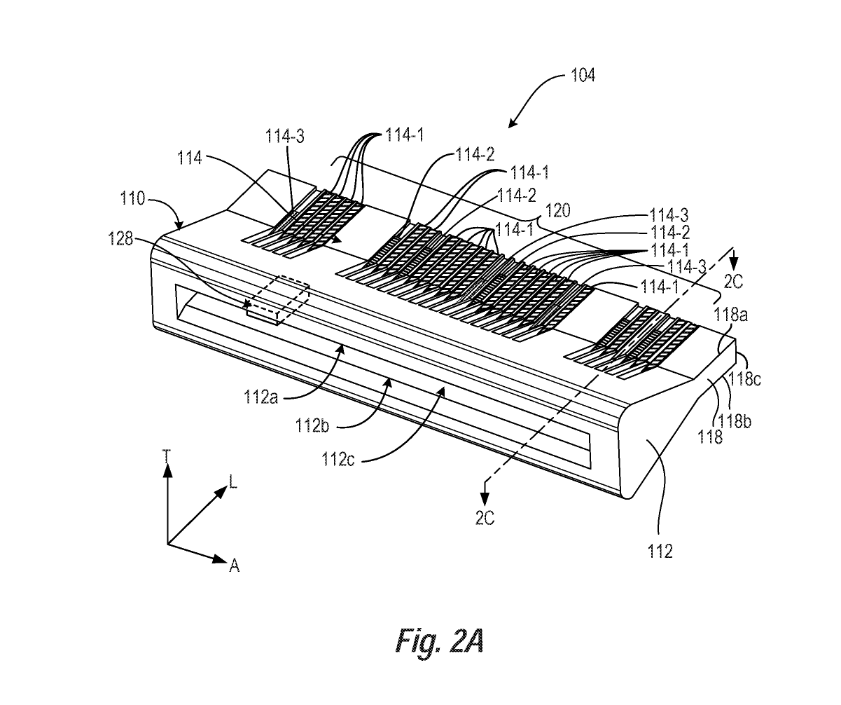

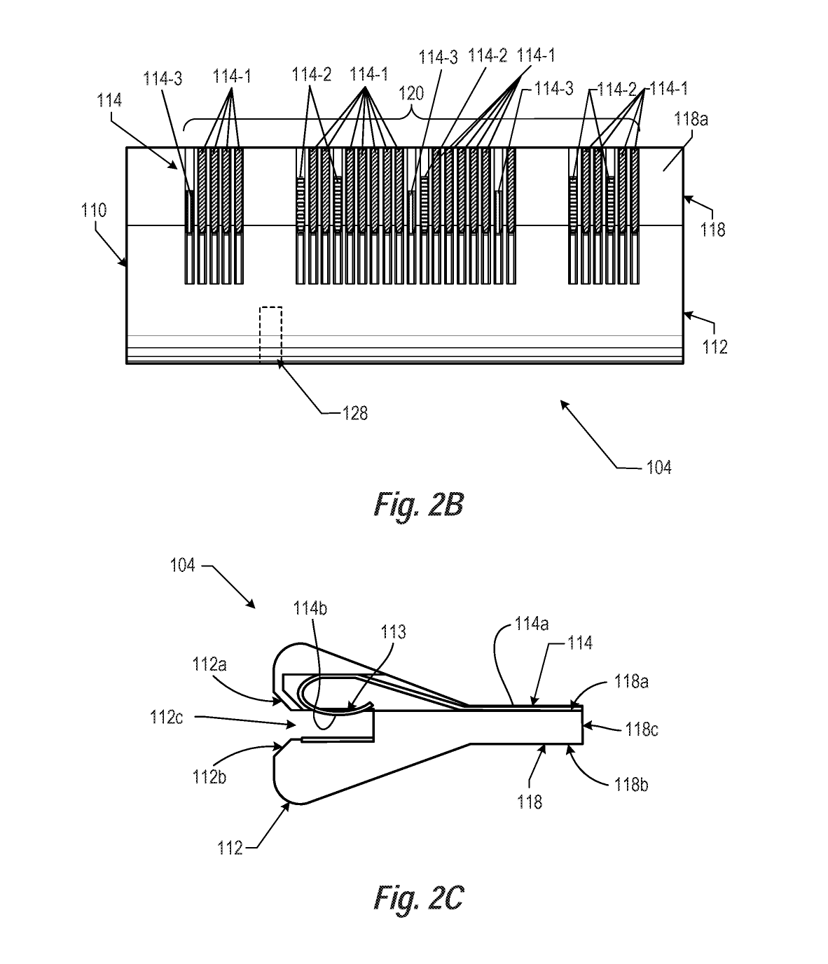

FIG. 2A through FIG. 2C show detailed views of the electrical connector adapter of FIG. 1 according to an example of the techniques of the present application. In particular, FIG. 2A shows a perspective detailed top view of the electrical connector adapter of FIG. 1, FIG. 2B shows a detailed top plan view of the electrical connector adapter of FIG. 2A, and FIG. 2C shows a detailed cross section view of the electrical connector adapter of FIG. 2A taken across lines 2A-2A according to an example of the techniques of the present application.

As explained above, electrical contacts 114 proximate chamber portion 112 are arranged in a non-staggered pattern 116. This non-staggered pattern 116 allows adapter 104 to establish or make a non-hot-plug electrical connection with electronic circuit board 102 when the electronic circuit board is inserted within interior 112c of chamber portion 112.

In one example, electrical contacts 114 proximate chamber portion 112 may be arranged in a non-staggered or single stage configuration with the contacts having substantially the same length or offset relative to each other, along longitudinal direction or length L. In one example, contacts 114 may be grouped or defined to have different functions in different patterns or arrangements. For example, contacts 114 may be defined as ground electrical contacts 114-1 (shown as diagonal lines) to carry ground signals, as control/data electrical contacts 114-2 (shown as horizontal lines) to carry control/data signals, and as power electrical contacts 114-3 (shown as vertical dashed lines) to carry power signals. In this manner, since the contacts proximate chamber portion 112 are of the same length, when circuit board 102 is inserted into chamber 112 portion, ground electrical contacts 114-1, control/data electrical contacts 114-2, and power electrical contacts 114-3 are configured to make a non-hot-plug electrical contact with complementary electrical contacts of electrical circuit board 102 at substantially the same time.

As explained above, electrical contacts 114 proximate extension portion 118 are arranged in a staggered pattern 120 in a row across first side 118a of exterior of the extension portion. This staggered pattern 120 allows adapter 104 to make a hot-plug electrical connection with external electrical connector 124 when the extension portion is inserted into interior 124c of external electrical connector 124.

In one example, electrical contacts 114 may be arranged in a multiple stage pattern or configuration portions having different lengths or offsets relative to each other. In a similar manner as the contacts 114 which are proximate chamber portion 112, electrical contacts 114 proximate extension portion 118 may be defined as ground electrical contacts to carry ground signals 114-1 (shown as diagonal lines), as control/data electrical contacts 114-2 (shown as horizontal lines) to carry control/data signals, and another portion of the contacts defined as power electrical contacts 114-3 (shown as vertical dashed lines) to carry power signals. In this manner, when extension portion 118 is inserted into interior portion 124c of external connector 124, electrical contacts 114 make a staggered or multi-staged connection with complementary contacts of external connecter 124. For example, ground electrical contacts 114-1 are configured to first make electrical contact with complementary ground electrical contacts of external electrical connector 124, control/data electrical contacts 114-2 are configured to next make electrical contact with complementary control/data electrical contacts of the external electrical connector, and power electrical contacts 114-3 are configured to last make electrical contact with the complementary power electrical contacts of the external electrical connector.

The contacts 114 proximate chamber portion 111 have substantially the same length extending along direction L extending away from chamber portion 111. On the other hand, contacts 114 proximate extension portion 118 have different lengths. For example, contacts 114-1 (shown as diagonal lines) have the longest length to make contact first, contacts 114-2 (shown as horizontal lines) have the next shortest length to make contact next, and contacts 114-3 (shown as vertical dashed lines) have the next shortest length to make contact last, extending along direction L away from extension portion 118.

In one example, electrical contacts 114 disposed on first side 112a proximate chamber portion 112 and electrical contacts 114 disposed on first side 118a proximate extension portion 118 are substantially coplanar (best shown in FIG. 2C). In another example, contact surfaces 114b of electrical contacts disposed proximate first side 112a of the chamber portion and contact surfaces 114a of the electrical contacts 114 disposed proximate the first side 118a of the extension portion are substantially coplanar. The contact surfaces 114b are configured to make electrical and contact with complementary contact surfaces of contact pads 106 of electronic circuit board 102. In a similar manner, contact surfaces 114a are configured to make electrical contact with complementary contact surfaces of electrical contacts 130 of external electrical connector 124. The electrical contacts 114 extend between chamber portion 112 and extension portion 118 to provide electrical conductive paths between contact pads 106 of electronic circuit board 102 and external connector 124. The electrical conductive paths may be established when adapter 104 is connected between electronic circuit board 102 and external connector 124. The electrical connection establishes electrical communication or electrical conductive paths with and between adapter 104 and external electrical connector 124 when electrical contacts 114 engage or make physical secure mechanical and electrical contact with electrical contacts 130 of connector 124.

In another example, each of the electrical contacts 114 comprises a single piece electrically conductive member with a resilient portion proximate chamber portion 112 that provides a continuous conductive path between the chamber portion 112 and the extension portion 118 before the extension portion is to make contact with the external connector. In another example, electrical contacts 114 provide non-interruptible electrical conductive paths extending between chamber portion 112 and extension portion 118 without having to be connected to electrical circuit board 102 or external electrical connector 124. In some other examples, electrical contacts 114 disposed proximate chamber portion 112 have a generally loop shape 113 to provide resilient contact with contacts pads of electronic circuit board 102. In this case, the interior and exterior portions of housing 110 proximate chamber portion 112 are shaped or dimensioned to accommodate the larger generally loop shape of electronic contacts 114 compared to the shape of extension portion. The electrical contacts 114 disposed proximate extension portion 118 have a generally flat shape to provide resilient contact with electrical contacts 130 of electrical connecter 124. In this case, the interior and exterior portions of housing 110 proximate extension portion 118 are generally rectangular in shape or dimensioned to accommodate the generally flat or rectangular shape of electronic contacts 114.

In one example, housing 110 may be shaped to accommodate contacts 114 so to provide ease of use when connecting and disconnecting electronic circuit board 102 to adapter 104 and connecting and disconnecting the adapter to the connector 124. For example, adapter 104 may be formed to have generally downward slope shape starting from chamber portion 112 and extending toward extension portion 118 along longitudinal direction L. The adapter 104 may have a generally rectangular shape proximate extension portion 118 to accommodate the shape the extension portion, along both longitudinal direction L and lateral direction A. The generally larger shape of chamber portion allows a user to grip the chamber portion for ease of handling the adapter. This combination of shapes may help a user better with the ability to better handle adapter 104 including inserting electronic circuit board to adapter and inserting adapter into external connector 124.

In some other examples, electrical contacts 114 disposed proximate chamber portion 112 have a generally loop shape 113 to provide resilient contact with contacts pads 106 of electronic circuit board 102. The loop shape 113 may be adjusted to adjust the retention force applied to contact pads 106 of electronic circuit board 102. For example, the retention force provided by loop 113 may be increased by increasing the strength created by the spring loaded contact. In one instance, the diameter of interior of loop 113 can be increased to increase the retention force. In a similar manner, the retention force provided by loop 113 may be decreased by decreasing the strength created by the spring loaded contact. In one instance, the diameter of interior of loop 113 can be decreased to decrease the retention force. In this case, the interior and exterior portion of housing 110 proximate chamber portion 112 may be shaped or dimensioned to accommodate the generally loop shape 113 of electronic contacts 114.

It should be understood that the adapter 104 above is for illustrative purposes and that the adapter may be configured in a different manner to implement the techniques of the present application. For example, the staggered pattern of contacts 114 proximate extension portion is for illustrative purposes and other patterns may be employed to practice the techniques of the present application. In one instance, the staggered pattern may include a pattern different than 3 different groups as described herein.

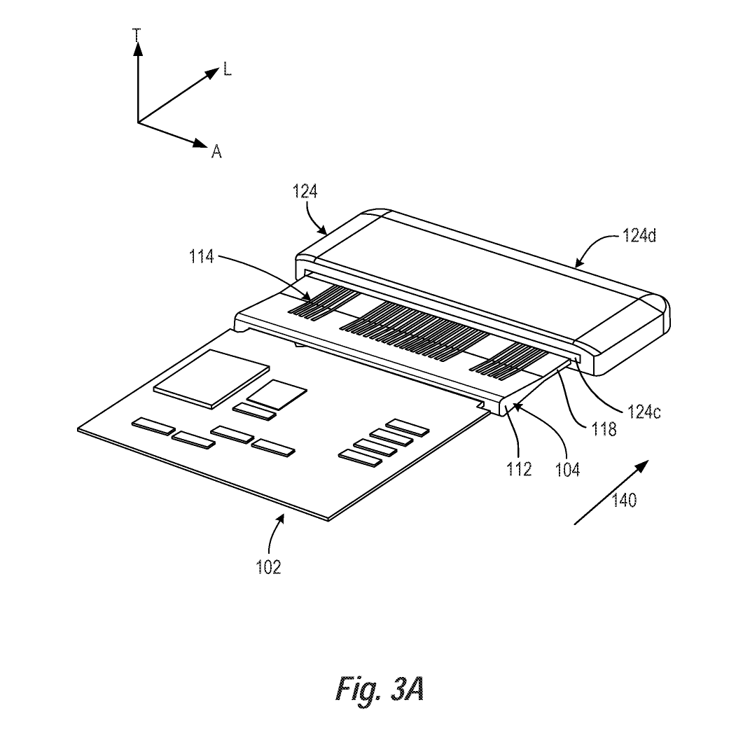

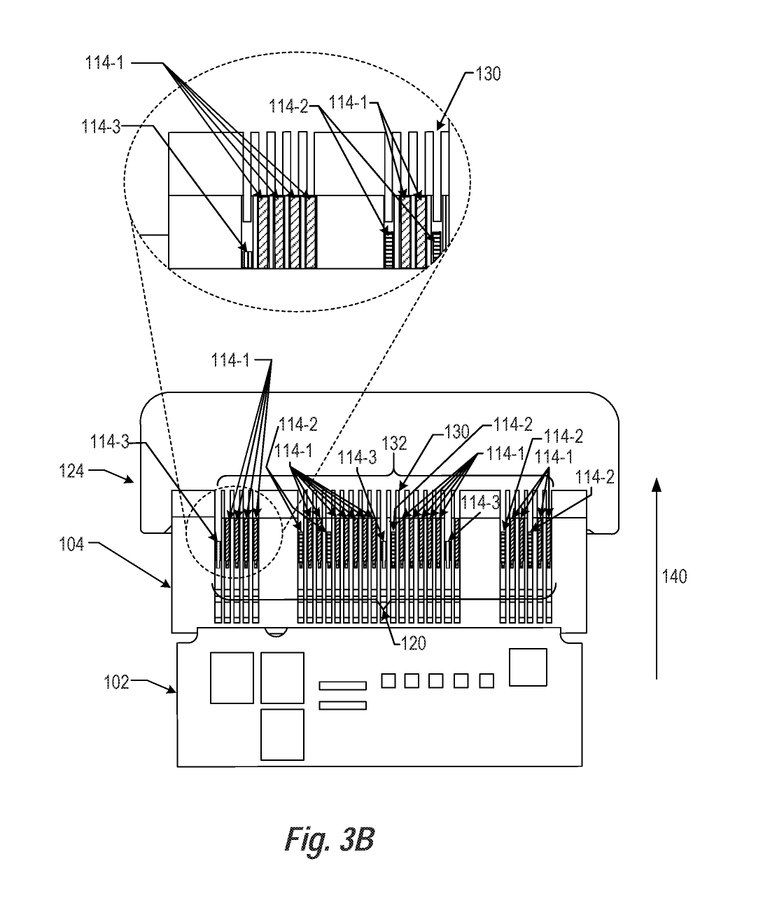

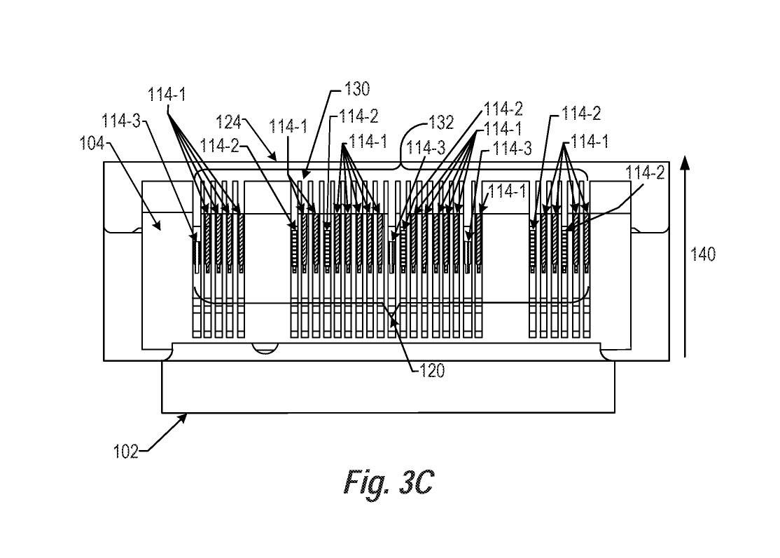

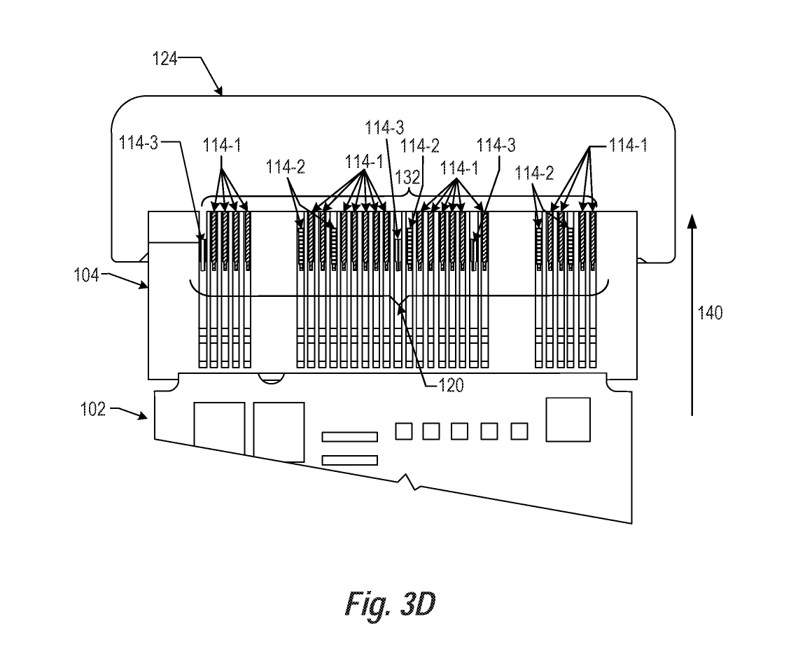

FIG. 3A through FIG. 3D shows electrical connector adapter of FIG. 1 as part of a process of being assembled as a connector adapter assembly according to an example of the techniques of the present application.

FIG. 3A shows a perspective top view and FIG. 3B shows a detailed top plan view of electrical connector adapter of FIG. 1 as an initial step in the process of being assembled as part of a connector adapter assembly according to an example of the techniques of the present application.

In one example, to illustrate operation, a computer system may be configured to have either a non-hot-plug or hot-plug external connector 124 that is user-accessible disposed on the front portion or panel of the computer. The user may have an electronic circuit board 102 with a non-hot-plug compatible connector that the user desires or intends to connect to the system. The user may employ electrical connector adapter 104 of the techniques of the present application to connect electronic circuit board 102 to external connecter 124 of the computer system. In one example, the user may begin the process by inserting electronic circuit 102 into adapter 104 to form an adapter assembly. Then as explained below in further detail, the user may proceed to connect adapter assembly to external connector or receptacle 124.

In an initial step in this process, a user may begin the assembly process by urging electronic circuit board 102 into interior portion 112c of chamber portion 112 of adapter 104 along direction L (shown by arrow 140). In particular, as electronic circuit board 102 is urged toward chamber portion 112 of adapter 104, electrical contact pads 106 proximate card edge 102c of electronic circuit board 102 are inserted into chamber portion of adapter 104. In this manner, contact pads 106 of electronic circuit board 102 begin to make electrical contact with electrical contacts 114 proximate chamber portion 112. As explained above, contacts pads 106 and electrical contacts 114 are both configured to have complementary non-staggered patterns to provide a non-hot-plug electrical connection when electronic circuit board 102 is inserted into chamber portion of adapter 104.

The user further urges electronic circuit board 102 toward adapter 104 to form electrical connecter assembly, as shown by arrow 140. Furthermore, as adapter assembly is urged toward external connector 124, electrical contacts 114 proximate extension portion 118 of adapter 104 begin to engage with interior 124c or chamber portion of electrical connector 124. In this case, first, ground electrical contacts 114-1 (shown as diagonal lines) make contact with complementary ground contacts 130 of external connector 124. In contrast, control/data electrical contacts 114-2 (shown as horizontal lines) and power electrical contacts 114-3 (shown as vertical dashed lines) have not yet made contact with electrical contacts 130 of external connecter 124. As explained below as the adapter assembly is further urged toward connecter 124, control/data electrical contacts 114-2 (shown as horizontal lines) makes contact with the connector and then power electrical contacts 114-3 (shown as vertical dashed lines) makes contact with the connecter. The electrical contacts 130 of external connecter 124 are shown as having a non-staggered pattern 132. However, it should be understood that electrical contacts 130 of external connecter 124 can be configured with a staggered pattern to implement the techniques of the present application.

FIG. 3C shows a detailed top plan view of electrical connector adapter of FIG. 3A in a further step in the process of being assembled as part of a connector adapter assembly according to an example of the techniques of the present application.

Continuing with the operation or step of FIG. 3B, as adapter assembly is further urged toward electrical connector 124 in the direction shown by arrow 140, control/data electrical contacts 114-2 (shown as horizontal lines) next make contact with complementary control/data contacts 130 of external connector 124. In addition, as explained above, ground electrical contacts 114-1 (shown as diagonal lines) have already made contact with complementary ground contacts 130 of external connector 124. In contrast, power electrical contacts 114-3 (shown as vertical dashed lines) have not yet made contact with electrical contacts 130 of external connecter 124.

FIG. 3D shows a detailed top plan view of electrical connector adapter of FIG. 3A as a subsequent step in the process of being assembled as part of a connector adapter assembly according to an example of the techniques of the present application.

Continuing with the operation or step of FIG. 3C, as adapter assembly is further urged toward electrical connector 124 in the direction shown by arrow 140, power electrical contacts 114-3 (shown as vertical dashed lines) next make contact with complementary power contacts 130 of external connector 124. In addition, as explained above, ground electrical contacts 114-1 (shown as diagonal lines) and control/data electrical contacts 114-2 (shown as horizontal lines) already have made contact with complementary ground contacts 130 of external connector 124. At this point in the process, ground electrical contacts 114-1 (shown as diagonal lines), control/data electrical contacts 114-2 (shown as horizontal lines) and power electrical contacts 114-3 (shown as vertical dashed lines) all have made contact with complementary ground contacts 130 of external connector 124. In this manner, insertion of adapter assembly (comprising adapter 104 and electronic circuit board 102) into external electrical connector 124 has established a hot-plug connection for electronic circuit board which has a non-hot-plug connector. As explained above, electrical contacts 114 proximate extension portion 118 of adapter 104 and electrical contacts 130 proximate opening of electrical connecter 124 are both configured with complementary configurations which provide a hot-plug electrical connection when adapter assembly is inserted into chamber portion of external connector 124.

Furthermore, as described above, each of electrical contacts 114 of adapter 104 may comprise a single piece electrically conductive member with a resilient portion proximate chamber portion 112 that may provide a continuous conductive path between chamber portion 112 and extension portion 118 before the extension portion is to make contact with external connector 124. In this manner, electronic circuit board 102, which has a non-hot-plug compatible connector, may be coupled to the system with a hot-plug compatible electrical connector. In this manner, adapter 104 may provide continuous conductive paths before making contact with the external connector which may reduce the need to have electronic switching circuitry as part of the adapter. Therefore, these techniques may thereby help reduce the cost of the adapter 104 and help increase the reliability of the adapter. In addition, electrical contacts 114 have a higher insertion cycle characteristic than the electrical contact pads 106. In this manner, adapter 104 may be able to accept electronic circuit board 102 having relatively low insertion cycle characteristics and convert it higher insertion cycle characteristics which may thereby increase the useful life of the electronic circuit board.

It should be understood that the process above is for illustrative purposes and that other configurations and steps or processes may be employed to implement the techniques of the present application. For example, the staggered pattern 120 of contacts 114 proximate extension portion 118 may have a different number of groups or stages of contact functions.

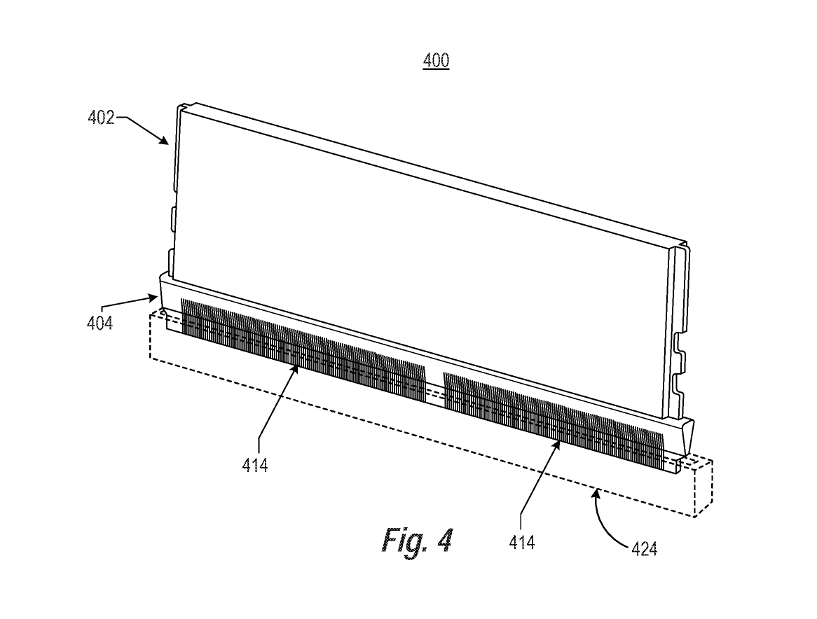

FIG. 4 shows a perspective view of another example of an electrical connector adapter that is part of an electrical connector adapter assembly 400 according to an example of the techniques of the present application. The electrical connector adapter assembly 400 shows an adapter 404 configured to connect an electronic circuit board 402 to an external connector 424 in accordance with the techniques of the present application. The adapter 404 is similar to the structure and function of adapter 104 described above. In one example, electronic circuit board 402 may be configured as a PCB with a memory circuit technology such as a Dual In-Line Memory Module (DIMM) or similar memory circuit technology. The adapter 404 includes two sets of contacts 414 to support DIMM modules. The DIMM modules may comprise a series of dynamic random-access memory integrated circuits, for example. The electronic circuit board 402 may be configured to have non-hot-plug connectors whereas external connecter 424 may have hot-plug connectors. The adapter 402 may be used to connect electronic circuit board 402 to external connecter 424. In this manner, the adapter 402 may improve the functionality of computing resources of a computer connected to connector 424 by adding or augmenting the resources of the electronic circuit board to the computer without having to impact the operation of the computer.

It should be understood that adapter 404 above is for illustrative purposes and that other configurations of the adapter may be employed to implement the techniques of the present application. For example, adapter 404 may have a different number or arrangement of contacts 414 to practice the techniques of the present application.

The techniques of the present application have been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur. Furthermore, the terms “comprise,” “include,” “have” and their conjugates, shall mean, when used in the present disclosure and/or claims, “including but not necessarily limited to.”

While the present techniques may be susceptible to various modifications and alternative forms, the exemplary examples discussed above have been shown only by way of example. It is to be understood that the techniques are not intended to be limited to the particular examples disclosed herein.

What is claimed is:

1. An electrical connector adapter comprising:
a housing body that defines a chamber portion with a first and a second opposite side, electrical contacts arranged in a non-staggered pattern in a row across the first side of an interior of the chamber portion to make a non-hot-plug electrical connection with an electronic circuit board when the electronic circuit board is inserted within the interior of the chamber portion, and
wherein the housing body defines an extension portion with a first side and a second opposite side, wherein each of the electrical contacts are arranged in a staggered pattern in a row across the first side of an exterior of the extension portion to make a hot-plug electrical connection with an external electrical connector, wherein each of the electrical contacts comprise a single piece electrically conductive member with a resilient portion proximate the chamber portion that provides a continuous conductive path between the chamber portion and the extension portion before the extension portion is to make contact with the external connector, and wherein the electrical contacts have higher insertion cycle characteristics than the electrical contact pads.

2. The electrical connector adapter of claim 1, wherein the electrical contacts arranged in the non-staggered pattern includes a single stage configuration with ground electrical contacts to carry ground signals, control/data electrical contacts to carry control/data signals and power electrical contacts to carry power signals, wherein the ground electrical contacts, the control/data electrical contacts, and the power electrical contacts are configured to make electrical a non-hot-plug contact with complementary electrical contacts of the external electrical connector at substantially the same time.

3. The electrical connector adapter of claim 1, wherein the electrical contacts arranged in the staggered pattern includes a multiple stage configuration with ground electrical contacts to carry ground signals, control/data electrical contacts to carry control/data signals and power electrical contacts to carry power signals, wherein the ground electrical contacts are configured to first make electrical contact with complementary ground electrical contacts of the external electrical connector, wherein the control/data electrical contacts are configured to next make electrical contact with complementary control/data electrical contacts of the external electrical connector, and wherein the power electrical contacts are configured to last make electrical contact with the complementary power electrical contacts of the external electrical connector.

4. The electrical connector adapter of claim 1, wherein the electrical contacts provide non-interruptible electrical conductive paths extending between the chamber portion and the extension portion.

5. The electrical connector adapter of claim 1, wherein contact surfaces of the electrical contacts at the first side of the chamber portion and contact surfaces of the electrical contacts at the first side of the extension portion are substantially coplanar.

6. The electrical connector adapter of claim 1, wherein the interior of the chamber portion includes a key portion to mate with a corresponding key portion on the electronic circuit board to ensure that the electronic circuit board is secured to the chamber portion in only one manner.

7. An electrical connector adapter comprising:
a housing body that defines a chamber portion with a first and a second opposite side, wherein electrical contacts are arranged in a non-staggered pattern in a row across the first side of an interior of the chamber portion to make a non-hot-plug electrical connection with an electronic circuit board when the electronic circuit board is inserted within the interior of the chamber portion, and
wherein the housing body defines an extension portion with a first side and a second opposite side, wherein the electrical contacts are arranged in a staggered pattern in a row across the first side of an exterior of the extension portion to make a hot-plug electrical connection with an external electrical connector, wherein each of the electrical contacts provides a continuous conductive path between the chamber portion and the extension portion before the extension portion is inserted into the opening of the external connector, and wherein the electrical contacts have higher insertion cycle characteristics than the electrical contact pads of the electronic circuit board.

8. The electrical connector adapter of claim 7, wherein the electrical contacts arranged in the non-staggered pattern includes a single stage configuration with ground electrical contacts to carry ground signals, control/data electrical contacts to carry control/data signals and power electrical contacts to carry power signals, wherein the ground electrical contacts, the control/data electrical contacts, and the power electrical contacts are configured to make non-hot-plug electrical contact with complementary electrical contacts of the external electrical connector at substantially the same time.

9. The electrical connector adapter of claim 7, wherein the electrical contacts arranged in the staggered pattern includes a multiple stage configuration with ground electrical contacts to carry ground signals, control/data electrical contacts to carry control/data signals and power electrical contacts to carry power signals, wherein the ground electrical contacts are configured to first make electrical contact with complementary ground electrical contacts of the external electrical connector, the control/data electrical contacts are configured to next make electrical contact with complementary control/data electrical contacts of the external electrical connector, and the power electrical contacts are configured to last make electrical contact with the complementary power electrical contacts of the external electrical connector.

10. The electrical connector adapter of claim 7, wherein contact surfaces of the electrical contacts at the first side of the chamber portion and contact surfaces of the electrical contacts at the first side of the extension portion are substantially coplanar.

11. An electrical connector adapter assembly comprising:
an electronic circuit board with electrical contact pads disposed on a first surface of the electronic circuit board; and
an electrical connector adapter including a housing body that defines a chamber portion with a first and a second opposite side, wherein electrical contacts are arranged non-staggered pattern in a row across the first side of an interior of the chamber portion to make a hot-plug electrical connection with the contact pads of the first side of the electronic circuit board when the electronic circuit board is inserted within the interior of the chamber portion, and wherein the housing body defines an extension portion with a first side and a second opposite side, and wherein the electrical contacts are arranged in a staggered pattern in a row across the first side of an exterior of the extension portion to make a hot-plug electrical connection with an external electrical connector, wherein all of the electrical contacts provide a continuous conductive path between the chamber portion and the extension portion before the extension portion makes contact with the external connector, and wherein the electrical contacts of the electrical connector have higher insertion cycle characteristics than the electrical contact pads of the electronic circuit board.

12. The electrical connector adapter assembly of claim 11, wherein the electrical contacts arranged in the non-staggered pattern includes a single stage configuration with ground electrical contacts to carry ground signals, control/data electrical contacts to carry control/data signals and power electrical contacts to carry power signals, wherein the ground electrical contacts, the control/data electrical contacts, and the power electrical contacts are configured to make electrical contact with complementary electrical contacts of the external electrical connector at substantially the same time.

13. The electrical connector assembly of claim 11, wherein the electrical contacts arranged in the staggered pattern includes a multiple stage configuration with ground electrical contacts to carry ground signals, control/data electrical contacts to carry control/data signals and power electrical contacts to carry power signals, wherein the ground electrical contacts are configured to first make electrical contact with complementary ground electrical contacts of the external electrical connector, wherein the control/data electrical contacts are configured to next make electrical contact with complementary control/data electrical contacts of the external electrical connector, and wherein the power electrical contacts are configured to last make electrical contact with the complementary power electrical contacts of the external electrical connector.

14. The electrical connector adapter assembly of claim 11, wherein contact surfaces of the electrical contacts at the first side of the chamber portion and contact surfaces of the electrical contacts at the first side of the extension portion are substantially coplanar.

15. The electrical connector adapter assembly of claim 11, wherein the electrical contacts extend between the chamber portion and the extension portion.
